(19) United States
(12) Patent Application Publication
(10) Pub. No.: US 2025/0289961 A1
(43) Pub. Date: Sep. 18, 2025

(54) COATING FORMULATION WITH IMPROVED COLOR RETENTION

(71) Applicant: Rohm and Haas Company, Collegeville, PA (US)

(72) Inventors: Timothy P. Moneypenny, Pottstown, PA (US); Keith A. Alderfer, Telford, PA (US); James C. Bohling, Lansdale, PA (US); Juan F. Callejas, Audubon, PA (US)

(21) Appl. No.: 18/862,755

(22) PCT Filed: May 15, 2023
(86) PCT No.: PCT/US2023/022203

§ 371 Date: Nov. 4, 2024

Related U.S. Application Data
(60) Provisional application No. 63/344,950, filed on May 23, 2022.

(51) Int. Cl. C09D 5/02; C08K 3/22; C08K 3/26; C09D 7/41; C09D 7/43; C09D 7/61; C09D 7/80; C09D 133/08

(52) U.S. Cl. CPC C09D 5/024; C08K 3/26; C09D 7/41; C09D 7/43; C09D 7/61; C09D 7/80; C09D 133/08; C08K 2003/2241

(57) ABSTRACT

The present invention is a coating formulation comprising water, a binder, a rheology modifier, and cerium (III) hydroxy carbonate. The coating formulation of the present invention exhibits improved tint retention as compared to coating formulations that do not include cerium (III) hydroxy carbonate.

### BACKGROUND OF THE INVENTION

The present invention relates to a coating formulation with improved color retention, more particularly, a paint formulation that comprises a cerium (III) hydroxy carbonate additive.

Cerium (III) carbonate has recently been reported to be an effective additive for improving tint retention and reducing color change in paint coatings. (See US 2021/1888227 A1 (Bohling), pp. 7-9.) Bohling discloses that a 20 wt. % aqueous wet paste of ligand-capped cerium (III) carbonate particles having a z-average particle size of 110±5 nm can be prepared by admixing a solution of ammonium cerium (III) nitrate and a solution of a chelating agent (EDTA) and ammonium carbonate, followed by centrifugation and supernatant removal. (Pg. 4, lines 4-6, and pg. 5, lines 1-6.) The chelating agent is believed to “promote the formation of the nanodisperse particles while stabilizing the particles against agglomeration.” (Pg. 3, lines 27-29.)

U.S. Pat. No. 8,637,153 B2 (Cho) discloses (col. 10, lines 5-29) a method for preparing a crystalline cerium (III) carbonate by first contacting a hydrate of Ce(NO₃)₃ with urea at a temperature in the range of from 80° C. to 100° C., then adding 10 to 30 weight percent of a polymer dispersant such as polyethylene glycol or polyacrylic acid to the admixture. (Col. 10, lines 22-24; and col. 5, lines 61-65.) Water is then removed, and the temperature is raised to 140° C. After completion of the reaction, the product may be washed with water to remove unreacted urea and the polymer dispersant, then dried to isolate a crystalline solid. The volume mean diameter of experimentally prepared particles are reported to be in the range of from 75 nm to 90 nm (Col. 12, Table 1); in general, Cho discloses that particle sizes are controllable by varying the amounts and molecular weights of the polymer dispersants. (Col. 8, lines 19-30.) The cerium (III) carbonate is then used as a precursor to prepare uniform sized cerium oxide nanoparticles. (Col. 13, lines 3-8.)

There is a need in the field of paint formulations to design additives that provide better color retention in paints.

### SUMMARY OF THE INVENTION

The present invention addresses a need in the art by providing a coating formulation comprising water, a binder, a rheology modifier, and cerium (III) hydroxy carbonate. The paint formulation of the present invention provides improved color retention and resists unwanted color change.

### DETAILED DESCRIPTION OF THE INVENTION

The present invention is a coating formulation comprising water, a polymeric binder, a rheology modifier, and cerium (III) hydroxy carbonate.

As used herein, “polymeric binder” refers to a polymeric material that is film forming on a desired substrate, with or without a coalescent. Examples of polymeric binders include acrylic, styrene-acrylic, urethane, alkyd, vinyl ester (e.g., vinyl acetate and vinyl versatate), and vinyl acetate-ethylene (VAE) polymeric polymeric binder, and combinations thereof.

Suitable rheology modifiers include hydrophobically modified ethylene oxide urethane polymers (HEURs), alkali swellable emulsions (ASEs) hydrophobically modified alkali swellable emulsions (HASEs), and hydroxyethylcellulosics (HECs).

In a further aspect, the coating formulation is a paint formulation that further comprise an opacifying pigment. Examples of suitable opacifying pigments include TiO₂, ZnO, and organic opacifying pigments such as opaque polymers.

In yet another aspect, the paint formulation is a tinted formulation that further comprises one or more colorants. Examples of suitable colorants include phthalocyanine blue, phthalocyanine green, monoarylide yellow, diarylide yellow, benzimidazolone yellow, heterocyclic yellow, DAN orange, quinacridone magenta, quinacridone violet, organic reds, including metallized azo reds and nonmetallized azo reds, carbon black, lampblack, black iron oxide, yellow iron oxide, brown iron oxide, red iron oxide.

Cerium (III) hydroxy carbonate, preferably in the form of a high solids content (from 25 to 75 weight percent) aqueous dispersion of cerium (III) hydroxy carbonate, is admixed with one or more ingredients used to make a paint or pre-paint formulation. The concentration of cerium (III) hydroxy carbonate, based on the weight of the paint formulation, is typically in the range of from 0.2 or from 0.5 or from 1 weight percent to 10 or to 8 or to 6 weight percent.

This dispersion is advantageously prepared by admixing cerium (III) hydroxy carbonate powder with a premix of water and the conjugate base of an acid functionalized dispersant. As used herein “a carboxylate” refers to a conjugate base (i.e., salt) of a carboxylic acid, wherein at least 90 percent or at least 95 or at least 99 percent of the carboxylic acid groups of the dispersant are in the form of the salt.

Suitable carboxylate functionalized dispersants include salts of polyacrylic acid and polymethacrylic acid homopolymers and copolymers such as the sodium salt of polyacrylic acid, commercially available as TAMOL™ 963 Dispersant (A trademark of The Dow Chemical Company or its Affiliates). The pH of the premix is advantageously increased using a suitable base such as ammonium hydroxide, preferably to a pH of ≥6.0.

The concentration of water in the dispersion is from 20 or from 25 or from 28 weight percent, to 70 or to 55 or to 40 or to 35 weight percent, based on the weight of the composition. The concentration of the cerium (III) hydroxy carbonate in the composition is in the range of from 25 or from 40 or from 55 or from 60 or from 65 weight percent, to 75 or to 72 or to 70 weight percent, based on the weight of the composition. The concentration of the carboxylate functionalized dispersant is in the range of from 0.5 or from 1 or from 1.5 weight percent, to 5 or to 3 or to 2.5 weight percent, based on the weight of the composition.

Cerium (III) hydroxy carbonate powder can be prepared by contacting at a temperature in the range of from 110° C. to 200° C., and in the substantial absence of a polymer dispersant, a cerium (III) nitrate and urea. As used herein, the term “substantial absence of a polymer dispersant” refers to less than 5, preferably less than 1, more preferably less than 0.1, and most preferably 0 weight percent, based on the weight of cerium (III) nitrate, of a polymer dispersant in a polymer melt of cerium (III) nitrate and urea. More particularly, a polymer dispersant refers to polyethylene glycol; a polymer functionalized with carboxylic acid groups such as polyacrylic acid and polymethacrylic acid; polyvinyl alcohol; or polyvinylpyrrolidone; or a combination thereof.

Preferably, the reaction is also conducted in the substantial absence of a chelating agent that is capable of forming a capping ligand with the cerium (III) hydroxy carbonate. The term “substantial absence of a chelating agent that is capable of forming a capping ligand with the cerium (III) hydroxy carbonate” refers to less than 1, preferably less than 0.5, more preferably less than 0.1, and most preferably 0 weight percent, based on the weight of cerium (III) nitrate, of the chelating agent, which is a) an amine carboxylic acid or a salt thereof, such as ethylene diamine tetraacetic acid (EDTA), ethylene diamine diacetic acid (EDDA), and nitrolotriacetic acid (NTA); and b) an amine phosphonic acid or a salt thereof such as aminotrimethyl phosphonic acid (ATMP), 6-amino-2-[bis(carboxymethyl)amino]hexanoic acid, and N-(phosphonomethyl)iminodiacetic acid (PIDA).

As used herein, “a cerium (III) nitrate” refers to an anhydrous or a hydrated cerium (III) nitrate. The cerium (III) nitrate is preferably used as a hydrate, more particularly a hexahydrate. The reaction of cerium (III) nitrate and urea is most preferably carried out under neat conditions, i.e., solvent-free and water-free, other than water arising from the hydrate. It is also preferred that the reaction be carried out with the combination of cerium (III) nitrate and urea comprising at least 95, or at least 98, or at least 99 or 100 weight percent of the components in the initial reaction mixture.

The mole-to-mole ratio of the cerium (III) nitrate to urea is preferably in the range of from 1:3, or from 1:4, or from 1:5, to 1:20, or to 1:10, or to 1:8. The reaction is carried out at a temperature in the range of from 110° C., or from 125° C., or from 140° C., to 200° C., or to 180° C., or to 160° C. and for a time sufficient to produce a satisfactory conversion of the desired product, generally in the range of from 1 to 10 hours. It has been discovered that particle size of the product can be controlled by adjusting the relative amounts of cerium (III) nitrate and urea and by varying temperature. In general, higher temperatures and higher urea: cerium (III) nitrate ratios were found to provide smaller particles sizes.

The paint formulation of the present invention has been found to exhibit improved color retention as compared with formulations that do not contain cerium (III) hydroxy carbonate. The formulation advantageously includes other additives including preservatives, dispersants, surfactants, defoamers, extenders, solvents, and coalescents.

### INTERMEDIATE EXAMPLE 1—PREPARATION OF CERIUM (III) HYDROXY CARBONATE

Cerium (III) nitrate hexahydrate (30.0 g, 69.1 mmol, 1 eq.) and urea (25.0 g, 416 mmol, 6 eq.) were added to a round bottom flask equipped with a stirring bar, a condenser and a Dean-Stark trap. The solid mixture was heated to 150° C. with stirring for 5 h. The mixture was allowed to cool to below 100° C., after which time water (80 g) was added to wash the material. The aqueous slurry was centrifuged at 18,500 rpm for 5 min, and the solids were separated, then subjected to three more rounds of washing and centrifugation. The solids were collected and allowed to dry at room temperature to yield 13.7 g (91.3% yield) of a white powder, identified by X-ray powder diffraction as hexagonal cerium (III) hydroxy carbonate. This material exhibited the same powder XRD pattern as observed in FIG. 7 of Cho.

### EXAMPLE 1—PREPARATION OF A CERIUM (III) HYDROXY CARBONATE COMPOSITION

A liquid premix of TAMOL™ 963 Dispersant (0.07 g), ammonium hydroxide (0.02 g, 28 wt. % aq.), and water (1.01 g) was added to a vessel containing dry cerium (III) hydroxy carbonate as prepared in Intermediate Example 1 (2.33 g). The mixture was pre-dispersed with a glass rod until a smooth textured slurry was obtained. The slurry was blended using a Flacktec dual axis mixer at 2900 rpm for 3 to 5 min. The pH of the slurry was found to be 6.5.

Table 1 illustrates semi-gloss paint formulations for blue and red paints with and without cerium (III) hydroxy carbonate (Ce(OH)CO₃). All numbers are reported as parts by weight. In-can Preservative refers to Kathon LX In-can Preservative (1.5 wt. % active); Dry Film Preservative refers to Bioban Dry Film Preservative; Dispersant refers to TAMOL™ 165A Dispersant; HW-1000 Surfactant refers to TRITON™ HW-1000 Surfactant; Defoamer refers to DOWSIL™ 8590 Defoamer; TiO₂ refers to Ti-Pure R-706 TiO₂; Extender refers to Minex 4 Extender; Photo TiO₂ refers to Aeroxide TiO₂ P25 (22 wt. % active); 15-S-12 Surfactant refers to TERGITOL™ 15-S-12 Surfactant; Latex refers to RHOPLEX™ AC-261LF Aqueous Emulsion; Coalescent refers to Optifilm Enhancer 400 Coalescent; RM-3030 refers to ACRYSOL™ RM-3030 Rheology Modifier; RM-8W refers to ACRYSOL™ RM-8W Rheology Modifier; Red Colorant refers to ColorTrend 808-0836 Organic Red; and Blue Colorant refer to ColorTrend 808-7214 Phthalo Blue. Photo TiO₂ is an anatase TiO₂ and is effective at accelerating the paint degradation process.

TABLE 1
Semi-gloss paint formulations with Ce(OH)CO₃

| | C Ex 1 | Ex 1 | Ex 2 | C Ex 2 | Ex 3 | Ex 4 |
|---|---|---|---|---|---|---|
| Paint Color | Blue | Blue | Blue | Red | Red | Red |
| Step 1: Cowles grind | | | | | | |
| Water | 7.52 | 7.50 | 7.47 | 7.53 | 7.51 | 7.48 |
| In-can Preservative | 0.16 | 0.16 | 0.16 | 0.16 | 0.16 | 0.16 |
| Dry Film Preservative | 0.53 | 0.53 | 0.53 | 0.53 | 0.53 | 0.53 |
| Dispersant | 0.80 | 0.80 | 0.80 | 0.80 | 0.80 | 0.80 |
| HW-1000 Surfactant | 0.18 | 0.18 | 0.18 | 0.18 | 0.18 | 0.18 |
| Defoamer | 0.09 | 0.09 | 0.09 | 0.09 | 0.09 | 0.09 |
| TiO₂ | 22.12 | 22.05 | 21.98 | 22.15 | 22.08 | 22.01 |
| Extender | 4.42 | 4.41 | 4.40 | 4.43 | 4.42 | 4.40 |
| Step 2: Flacktec | | | | | | |
| dispersion addition | | | | | | |
| Ce(OH)CO₃ (69 wt. % aq.) | 0.00 | 0.64 | 1.27 | 0.00 | 0.64 | 1.27 |
| Photo TiO₂ | 7.94 | 7.91 | 7.89 | 7.95 | 7.92 | 7.90 |
| Step 3: Let-Down | | | | | | |
| 15-S-12 Surfactant | 0.18 | 0.18 | 0.18 | 0.18 | 0.18 | 0.18 |
| Latex | 40.35 | 40.21 | 40.08 | 40.40 | 40.26 | 40.13 |
| Ammonia (28%) | 0.09 | 0.09 | 0.09 | 0.09 | 0.09 | 0.09 |
| Defoamer | 0.05 | 0.05 | 0.05 | 0.05 | 0.05 | 0.05 |
| Propylene Glycol | 0.19 | 0.19 | 0.19 | 0.19 | 0.19 | 0.19 |
| Coalescent | 1.99 | 1.99 | 1.98 | 2.00 | 1.99 | 1.98 |
| RM-3030 | 0.58 | 0.59 | 0.57 | 0.58 | 0.59 | 0.57 |
| RM-8W | 0.19 | 0.22 | 0.21 | 0.19 | 0.22 | 0.21 |
| Water | 9.40 | 9.02 | 8.70 | 9.41 | 9.03 | 8.71 |
| Step 4: Colorant Addition | | | | | | |
| Red Colorant | 0.00 | 0.00 | 0.00 | 3.10 | 3.09 | 3.08 |
| Blue Colorant | 3.22 | 3.21 | 3.20 | 0.00 | 0.00 | 0.00 |
| Total Wt | 100 | 100 | 100 | 100 | 100 | 100 |

### Procedure for Measuring Color Retention

ASTM D4587-11 was used to simulate natural exterior weathering from sunlight and moisture cycles that are typical for exterior coatings. Cycle #4 from Table 1 of the ASTM method describes the conditions used. QUV Accelerated Weathering Tester model QUV/se was used for the accelerated weathering experiments. Q-Panel (AL-36 3″×6″) chrome treated aluminum panels were used as the substrates for the coating applications. A vacuum plate was used to hold the aluminum panels during application of the test paint. A 10-mil edge of a 2″ width multiple clearance film applicator was used to apply the coatings with an approximate wet film thickness of 5 mil. Coated panels were allowed to dry over 7 d in a controlled temperature lab (72° F. (˜24° C.)/50% relative humidity) before exposure to accelerated weathering. A BYK Specto-guide 45/0 spectrophotometer (cat: 6801) was used to record L*, a*, b* color values. Color values were recorded prior to exposure in the QUV unit (Time=0) and at approximate increments of 500 h total QUV unit operation time. The 500-h testing increments were continued for 1951 h, which was found sufficient to observe differentiated degradation between experimental samples. ΔL* was measured to compare test results from exposed panels. Higher ΔL* values (L*_{f}-L*ₒ) indicate a lighter color of the exposed coating, characteristic of typical paint color fade. Table 2 illustrates the results of the exposure testing.

TABLE 2
Exposure Test Results

| Paint ID | ΔL* |
|---|---|
| C Ex 1 | 3.84 |
| Ex 1 | 1.82 |
| Ex 2 | 1.44 |
| C Ex 2 | 2.77 |
| Ex 3 | 1.92 |
| Ex 4 | 1.54 |

The ΔL* values for the samples containing cerium (III) hydroxy carbonate show marked improvement in retaining tint over the control samples.

1. A coating formulation comprising water, a binder, a rheology modifier, and cerium (III) hydroxy carbonate.

2. The coating formulation of claim 1 which is a paint formulation that further comprises an opacifying pigment.

3. The paint formulation of claim 2 which further comprises a tint.

4. The paint formulation of claim 3 wherein the binder is an acrylate or styrene-acrylate polymer binder, the opacifying pigment is TiO₂, and the rheology modifier is a hydrophobically modified ethylene oxide urethane polymer.

5. The paint formulation of claim 2 wherein the concentration of cerium (III) hydroxy carbonate is in the range of from 0.2 to 10 weight percent, based on the weight of the paint formulation.

6. The paint formulation of claim 4 wherein the concentration of cerium (III) hydroxy carbonate is in the range of from 0.5 to 6 weight percent, based on the weight of the paint formulation.

7. The paint formulation of claim 2 which further comprises one or more additives selected from the group consisting of preservatives, dispersants, surfactants, defoamers, extenders, solvents, and coalescents.

8. The paint formulation of claim 2 which further comprises a dispersant, a surfactant, an extender, and a defoamer.

9. A method for preparing a coating composition comprising the step of admixing an aqueous dispersion of cerium (III) hydroxy carbonate and a carboxylate functionalized dispersant with materials comprising a binder and a rheology modifier, wherein the concentration of cerium (III) hydroxy carbonate in the aqueous dispersion is in the range of from 25 to 75 weight percent, based on the weight of the dispersion, and the concentration of the carboxylate functionalized dispersant in the composition is in the range of from 0.5 to 8 weight percent, based on the weight of the dispersion.

10. The method of claim 9 wherein the aqueous dispersion of cerium (III) hydroxy carbonate is further admixed an opacifying pigment and a colorant; wherein the concentration of cerium (III) hydroxy carbonate in the aqueous dispersion is in the range of from 40 to 72 weight percent, based on the weight of the dispersion, and the concentration of the carboxylate functionalized dispersant is in the range of from 1 to 5 weight percent, based on the weight of the dispersion; and wherein the concentration of cerium (III) carbonate in the composition is in the range of from 0.2 to 10 weight percent.

11. The method of claim 10 wherein the concentration of cerium (III) hydroxy carbonate in the aqueous dispersion is in the range of from 65 to 70 weight percent, based on the weight of the dispersion, and the concentration of the carboxylate functionalized dispersant is in the range of from 1.5 to 3.5 weight percent, based on the weight of the dispersion, wherein the carboxylate functionalized dispersant is a salt of polyacrylic acid.
